(19) United States
(12) Patent Application Publication
(10) Pub. No.: US 2017/0030290 A1
(43) Pub. Date: Feb. 2, 2017

(54) RECESS TO ENCOURAGE RING LIFT

(71) Applicant: General Electric Company, Schenectady, NY (US)

(72) Inventors: Richard John Donahue, West Bend, WI (US); Kenneth Edward Neuman, Waukesha, WI (US)

(21) Appl. No.: 14/814,099

(22) Filed: Jul. 30, 2015

(51) Int. Cl. F02F 3/00; F16J 9/12

(52) U.S. Cl. CPC F02F 3/00; F16J 9/12

(57) ABSTRACT

A system, includes a piston. The piston has a first outer diameter and includes an annular ring groove that receives a ring. The annular ring groove is defined by a top surface, a bottom surface, and an inner surface that extends between the top surface and the bottom surface in an axial direction along a longitudinal axis of the piston. The inner surface has an inner diameter that is less than the outer diameter. The bottom surface has a recess that extends both in the axial direction and a radial direction relative to the longitudinal axis.

### BACKGROUND

The subject matter disclosed herein relates to reciprocating engines and, more specifically, to one or more rings of a piston in a reciprocating engine.

A reciprocating engine (e.g., an internal combustion engine such as a diesel, gasoline, or gas engine) combusts fuel with an oxidant (e.g., air) to generate high temperature, high pressure combustion gases, which in turn drive a piston (e.g., reciprocating piston) within a cylinder. In particular, the high temperature, high pressure combustion gases expand and exert a pressure against the piston that linearly moves the position from a top portion to a bottom portion of the cylinder during an expansion stroke. The piston converts the pressure exerted by the combustion gases (and the piston's linear motion) into a rotating motion (e.g., via a connecting rod and a crank shaft coupled to the piston) that drives one or more loads (e.g., an electrical generator). In some engines, a ring (e.g., top ring) may not lift away from bottom flank of the ring groove in the piston head during exhaust and intake. The inability of the ring to lift may result in carbon deposits, and premature wear of components.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a system, includes a piston. The piston has a first outer diameter and includes an annular ring groove that receives a ring. The annular ring groove is defined by a top surface, a bottom surface, and an inner surface that extends between the top surface and the bottom surface in an axial direction along a longitudinal axis of the piston. The inner surface has an inner diameter that is less than the outer diameter. The bottom surface has a recess that extends both in the axial direction and a radial direction relative to the longitudinal axis.

In a second embodiment, a system includes a ring configured to be disposed within an annular ring groove of a piston within a combustion engine. The ring has a top surface, a bottom surface, an inner surface. The inner surface extends between the top and bottom surfaces and defines an inner diameter of the ring. An outer surface extends between the top and bottom surfaces and defines an outer diameter of the ring. The ring comprises a first recess in the bottom surface that during operation of the combustion engine reduces the pressure load acting on the ring in an axial direction relative to a longitudinal axis of the piston. The recess extends in both the axial direction and a radial direction relative to the longitudinal axis.

In a third embodiment, a system includes a turbocharger and a combustion engine. The combustion engine is fluidly coupled to the turbocharger and includes a piston and a ring. The piston has a first outer piston diameter and an annular ring groove configured to receive a ring. The annular ring groove is defined by a top groove surface, a bottom groove surface, and an inner groove surface that extends between the top groove surface and the bottom groove surface in an axial direction along a longitudinal axis of the piston. The inner groove surface has an inner groove diameter that is less than the outer piston diameter. The bottom groove surface has a groove recess that extends both in the axial direction and a radial direction relative to the longitudinal axis. The ring is configured to be disposed within the annular ring groove. The ring has a top ring surface, a bottom ring surface, an inner ring surface. The inner ring surface extends between the top ring surface and bottom ring surface and defines an inner ring diameter of the ring. An outer ring surface extends between the top ring surface and bottom ring surface and defines an outer ring diameter of the ring. The ring includes a top recess and a bottom recess. The top recess is in the top ring surface and extends in both the axial direction and a radial direction relative to the longitudinal axis. The bottom recess is in the bottom ring surface and during operation of the combustion engine reduces the pressure load acting on the ring in an axial direction relative to a longitudinal axis of the piston, wherein the bottom recess extends in both the axial direction and a radial direction relative to the longitudinal axis.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a block diagram of an embodiment of engine driven power generation system in accordance with aspects of the present disclosure;

FIG. 2 is a cross-sectional side view of an embodiment of a reciprocating engine in accordance with aspects of the present disclosure;

FIG. 3 shows a top ring that is not lifting;

FIG. 4 shows a top ring that is lifting;

FIG. 5 is a bottom view of a top ring with recesses in accordance with aspects of the present disclosure;

FIG. 6 is a section view of a top ring with recesses on the top flank and bottom flank in accordance with aspects of the present disclosure;

FIG. 7 is a top-down section view of a piston at the top ring groove with recesses in accordance with aspects of the present disclosure;

FIG. 8 is a section view of a piston with recesses on the bottom surface of the top ring groove in accordance with aspects of the present disclosure;

FIG. 9 shows an embodiment in which the recesses are on the top ring in accordance with aspects of the present disclosure; and

FIG. 10 shows an embodiment in which the recesses are in the bottom surface of the top ring groove in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

In a reciprocating engine, a piston reciprocates within a cylinder. A ring (e.g., top ring) may be disposed within a ring groove (e.g., top ring groove) of the piston. The ring may be configured to move up and down within the ring groove as the piston reciprocates. Specifically, the upward inertial force of the ring may cause the ring to lift as the piston approaches top dead center (TDC). As the piston approaches bottom dead center (BDC), the inertial force of the ring is downward. The up and down movement of the ring may release pressure, as well as scrub the interior surface of the ring groove. However, in some engines (e.g., turbocharged engines), the pressure in the combustion chamber remains high when the valves open. The high pressure may keep the ring pinned against the bottom flank of the ring groove, keeping the ring from lifting. Recesses in the ring or the bottom flank of the ring groove may relieve pressure on the ring, enabling the ring to lift due to inertia during some portions of the engine cycle (e.g., exhaust and intake).

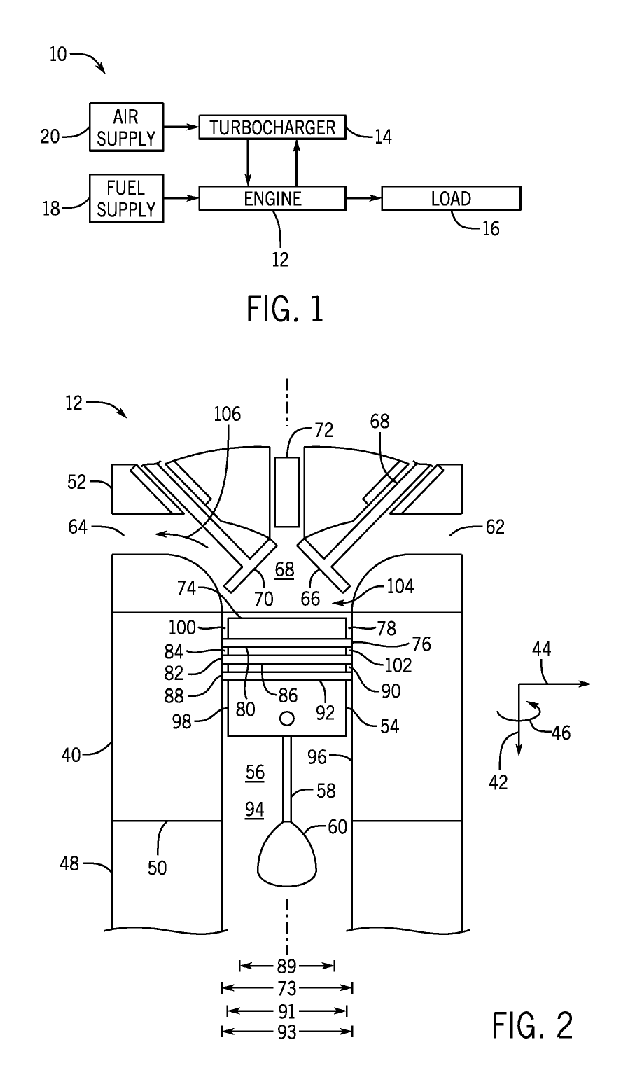

Turning now to the drawings and referring first to FIG. 1, a block diagram of an embodiment of engine driven power generation system 10 is shown. The engine driven power system 10 includes an engine 12. The engine 12 may include a reciprocating or piston engine (e.g., internal combustion engine). The engine 12 may include a spark-ignition engine or a compression-ignition engine. The engine 12 may include a natural gas engine, gasoline engine, diesel engine, or dual fuel engine. The engine 12 may be a two-stroke engine, three-stroke engine, four-stroke engine, five-stroke engine, or six-stroke engine. The engine 12 may also include any number of cylinders (e.g., 1-24 cylinders or any other number of cylinders) and associated piston and liners.

The power generation system 10 includes the engine 12, a turbocharger 14, and a generator/mechanical drive 16. Depending on the type of engine 12, the engine receives fuel 18 (e.g., diesel, natural gas, coal seam gases, associated petroleum gas, etc.) or a mixture of both the fuel 18 and a pressurized oxidant 20, such as air, oxygen, oxygen-enriched air, or any combination thereof. Although the following discussion refers to the oxidant as the air 20, any suitable oxidant may be utilized with the disclosed embodiments. The fuel 18 or mixture of fuel 18 and pressurized air 20 is fed into the engine 12. The engine 12 combusts the mixture of fuel 18 and air 20 to generate hot combustion gases, which in turn drive a piston (e.g., reciprocating piston) within a cylinder. In particular, the hot combustion gases expand and exert a pressure against the piston that linearly moves the piston from a top portion to a bottom portion of the cylinder liner during an expansion stroke. The piston converts the pressure exerted by the combustion gases (and the piston's linear motion) into a rotating motion (e.g., via a connecting rod and a crank shaft coupled to the piston). The rotation of the crank shaft drives the electrical generator 16 to generate power or other power consumer. Alternatively, the crank shaft drives a mechanical drive 16. In certain embodiments, exhaust from the engine 12 may be provided to the turbocharger 14 and utilized in a turbine portion of the turbocharger 14, thereby driving a compressor of the turbocharger 14 to pressurize the air 20. In some embodiments, the power generation system 10 may not include all of the components illustrated in FIG. 1. In addition, the power generation system 10 may include additional components such as control components and/or heat recovery components. In certain embodiments, the turbocharger 14 may be utilized as part of the heat recovery components. The system 10 may generate power ranging from 10 kW to 10 MW or greater. Beyond power generation, the system 10 may be utilized in other applications such as those that recover heat and utilize the heat (e.g., combined heat and power applications), combined heat, power, and cooling applications, applications that also recover exhaust components (e.g., carbon dioxide) for further utilization, gas compression applications, and mechanical drive applications. In engines 12 coupled to a turbocharger 14, or other engines that experience elevated pressures in the combustion chamber during exhaust and intake, ring lift may not occur. Recesses at the interface of the ring and the bottom surface of the ring groove (either in the ring or in the bottom surface of the ring groove) may help to relieve pressure on the ring, enabling the ring to lift during operation.

FIG. 2 is a cross-sectional side view of an embodiment of the reciprocating or piston engine 12. In the following discussion, reference may be made to longitudinal axis or direction 42, a radial direction 44, and/or a circumferential direction 46 of the engine 12. As mentioned above, in certain embodiments, the engine 12 may include multiple cylinders (e.g., 2, 4, 6, 8, 10, 12, 14, 16, 18, 20, 22, or 24 cylinders). The engine 12 includes a cylinder 40 having a crankcase 48 coupled to a bottom end 50 of the cylinder 40, a cylinder head 52 coupled to the cylinder 40, a piston 54 disposed in a cavity 56 within the cylinder 40, and a connecting rod 58 coupled to the piston 54 within the cylinder 40 and to a crankshaft 60 within the crankcase 48. The cylinder head 52 includes an intake port 62 for receiving air or a mixture of fuel and air and an exhaust port 64 for discharging exhaust from the engine 12. An intake valve 66, disposed within the cylinder head 52 and the intake port 62, opens and closes to regulate the intake of air or the mixture of fuel and air into the engine 12 into a portion 68 of the cavity 56 above the piston 12. An exhaust valve 70, disposed within the exhaust port 64, opens and closes to regulate discharge of the exhaust from the engine 12. In certain embodiments (e.g., spark-ignition engine), a spark plug 72 extends through a portion of the cylinder head 52 and interfaces with the portion 68 of the cavity 56 where combustion occurs. In some embodiments (e.g., compression-ignition engine), the spark plug is absent (or is replaced with a glow plug) and ignition occurs primarily due to compression of the mixture of air and fuel.

The piston 54 has an outside diameter 73 and includes crown 74, and a top ring 76 (e.g., annular compression ring) disposed beneath a top land 78 and within a top ring groove 80 (e.g., an annular groove) of the piston 54, a second ring 82 (e.g., annular compression ring) disposed beneath a second land 84 and within a second ring groove 86 of the piston 54, and a third ring 88 (e.g., annular oil ring) disposed beneath a third land 90 and within a third ring groove 92 of the piston 54. It should be understood, however, that in some embodiments (e.g., a piston having a ring pack with a single compression ring) the piston 54 may not have a second ring 82. The grooves 80, 86, 92 may gave an inside diameter 89. The rings 76, 82, 88 have an inside diameter 91, and an outside diameter 93. The rings 76, 82, 88 may include a height less than a height of their respective grooves 80, 86, 92 creating a respective gap between the ring 76, 82, 88 and adjacent lands (e.g., bottom surfaces of the lands or top surfaces of the groove) above each respective ring 76, 82, and 88. The first and second rings 76, 82 seal the portion 68 (e.g., combustion chamber) of the cavity 56, so that gases do not transfer into a portion 94 of the cavity 56 below the piston 54 into the crankcase 48. The third ring 88 regulates the consumption of engine oil. An inner surface 96 of the cylinder 40 and an outer surface 98 of the piston 54 (e.g., the top land 78 and the first ring groove 80) at the top land 78 define a top land cavity or crevice 100. Pressure within the portion 68 of the cavity 56 above the piston 54 generally maintains a boundary (generally extending from an uppermost portion of the piston 54 radially 28 toward the inner surface 96 of the cylinder 24) between the portion 68 of the cavity 56 and the top land cavity 100. As previously discussed, when the engine 12 has a turbocharger 14, or otherwise experiences elevated pressure in in the combustion chamber during exhaust and intake, the top ring may not lift. By including recesses along the interface between the toping ring and the bottom surface of the top ring groove, the pressure “gets behind” the top ring, reducing the pressure load on the top ring and enabling top ring lift. For the sake of clarity, recesses in the ring and/or ring groove will hereinafter be discussed as being disposed on the top ring 76 and/or the top ring groove 80. However, it should be understood that the disclosed techniques may be applied to the second ring 82, the third ring 88, or any other ring in a ring pack. The first and second rings 76, 82, the inner surface 96 of the cylinder 40, and the outer side surface 98 of the piston 54 (e.g., including the second land 84 and the second ring groove 86) define an interring cavity or crevice 102 (i.e., cavity between the top ring 76 and the second ring 82).

Opening of the intake valve 50 enables a mixture of fuel and air to enter the portion 68 of the cavity 94 above the piston 54 as indicated by arrow 104. With both the intake valve 66 and the exhaust valve 70 closed and the piston 54 near top dead center (TDC) (i.e., position of piston 54 furthest away from the crankshaft 44, e.g., near the top end of the cylinder 40), combustion of the mixture of air and fuel occurs due to spark ignition (in other embodiments due to compression ignition). Hot combustion gases expand and exert a pressure against the piston 54 that linearly moves the position of the piston 54 from a top portion (e.g., at TDC) to a bottom portion of the cylinder 40 (e.g., at bottom dead center, BDC) along the longitudinal axis 108 of the cylinder 40, which is the position of the piston 54 closest to the crankshaft 44, e.g., near the bottom end 34 of the cylinder 40) during an expansion stroke. The piston 54 converts the pressure exerted by the combustion gases (and the piston's linear motion) into a rotating motion (e.g., via the connecting rod 58 and the crank shaft 60 coupled to the piston 54) that drives one or more loads (e.g., electrical generator 16).

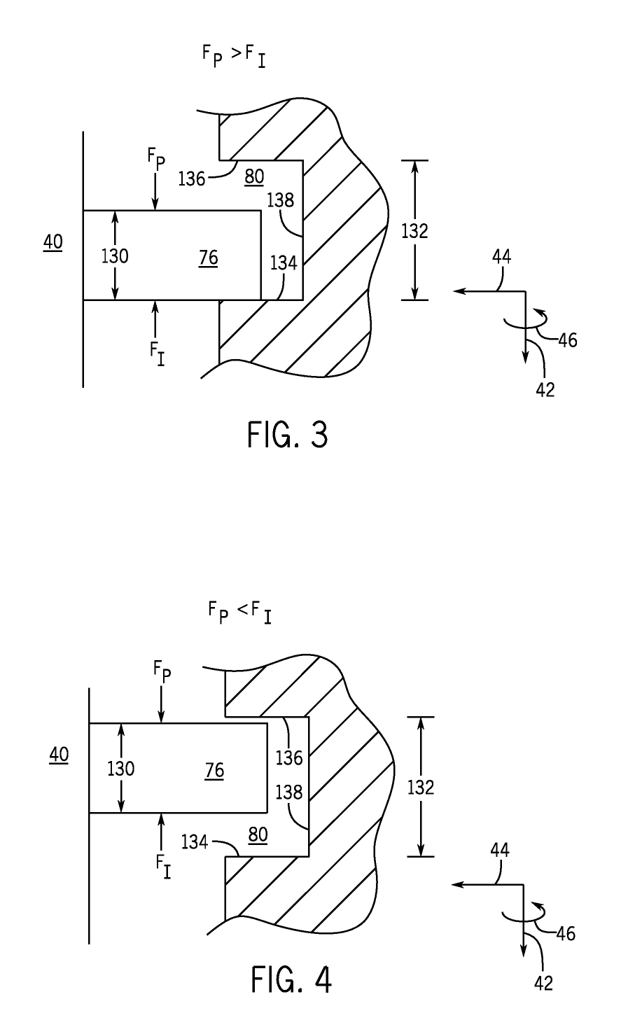

FIGS. 3 and 4 show top ring 76 lift. The top ring groove 80 is defined by a bottom surface 134, a top surface 136, and an interior surface 138. The top ring groove 80 has a height 132. As previously discussed, the height 130 of the top ring 76 is less than the height 132 of the top ring groove 80, such that there is some play in the interface between the top ring 76 and the top ring groove 80. As the piston 54 approaches TDC, the inertial force, F_{I}, pushes up on the top ring 76, as shown in FIG. 3. For approximately half of the engine cycle, or slightly less than half of the engine cycle, centered around TDC, the inertial force, F_{I}, pushes up on the top ring 76. For the rest of the engine cycle, centered around BDC (not shown in FIG. 3), the inertial force, F_{I}, aligns with pressure force F_{P} and pushes down on the top ring 76. Accordingly, the top ring 76 stays in contact with the bottom surface 134 of the top ring groove 80 for most of the combustion cycle. Top ring 76 lift only occurs when the inertial force, F_{I}, pushing up on the top ring 76 exceeds the pressure force, F_{P}, pushing down on the top ring 76 due to the pressure in the combustion portion 68. When the top ring 76 is pushed against the bottom surface 134 of the top ring groove 80, a seal is created between the portion 94 below the piston 54 and the combustion portion 68 above the piston, maintaining pressure in the combustion portion 68. However, during intake and exhaust, when the piston 54 is around TDC, the pressure in the combustion portion is reduced and the inertial force, F_{I}, pushing the top ring 76 up exceeds the force, F_{P}, pushing down on the top ring 76 due to the pressure. The top ring 76 may then lift off of the bottom surface 134 of the top ring groove 80. A top ring 76 that lifts off of the bottom surface 134 of the top ring groove 80 during intake and exhaust serves a desirable purpose. By moving up and down once per engine cycle, the top ring 76 scrubs the top ring groove 80, avoiding the buildup of carbon deposits.

However, in some engines (e.g., highly turbocharged engines), the pressure in the combustion portion 68 remains high during intake and exhaust. For example, in a turbocharged engine 12, the increased airflow due to the turbocharger 14 may keep the pressure in the combustion portion 68 during intake and exhaust higher than in an engine 12 without a turbocharger 14. In such cases, the force, F_{P}, pushing down on the top ring 76 due to the pressure in the combustion portion 68 may remain higher than the inertial force, F_{I}, pushing up on the top ring 76 due to inertia during exhaust and intake. As such, the top ring 76 may never or infrequently lift off of the bottom surface 134 of the top ring groove 80.

When the top ring 76 does not lift, it may lead to carbon build up on the top ring 76 or in the top ring groove. When carbon deposits build up in the top ring groove 80, the top ring 76 may get stuck within the top ring groove. A sticking top ring 76 may experience thrust forces from the piston 54, which may result in scuffing. The carbon build up may also restrict the air flow path to the back of ring such that the pressure cannot get behind top ring. When the pressure is unable to get behind the top ring 76, the top ring may experience excessive radial pressure, which may result in top ring 76 collapse (i.e., the top ring is pushed back into the groove away from the liner, breaking the seal between the ring and the liner). In some cases, a collapsed top ring 76 may be incapable of forming a seal. A radially collapsed top ring 76 may also lead to high engine 12 temperatures, top ring 76 scuffing, high oil consumption, and possible engine shutdown. Moreover, a top ring 76 that does not lift due to the high downward pressure force may cause excessive wear of the bottom surface 134 of the top ring groove 80.

In order to achieve top ring 76 lift in turbocharged engines and other engines with higher pressures in the combustion portion 68 during intake and exhaust, or to reduce the pressure force on the top ring 76 (and wear on the bottom surface 134 of the top ring groove 80) in engines with high pressure gradients across the top ring (e.g., pistons having ring packs with only 1 compression ring), one or more recesses may be added to the interface between the top ring 76 and the bottom surface 134 of the top ring groove 80. The recesses may be disposed in the top ring 76, in the bottom surface 134 of the top ring groove 80, or both. The recesses allow the pressure to get behind the top ring 76, reducing the downward force on the top ring 76 due to pressure. Reduced force due to pressure allows the top ring to lift during exhaust and intake and may also reduce wear on the top ring 76 or the top ring groove 80.

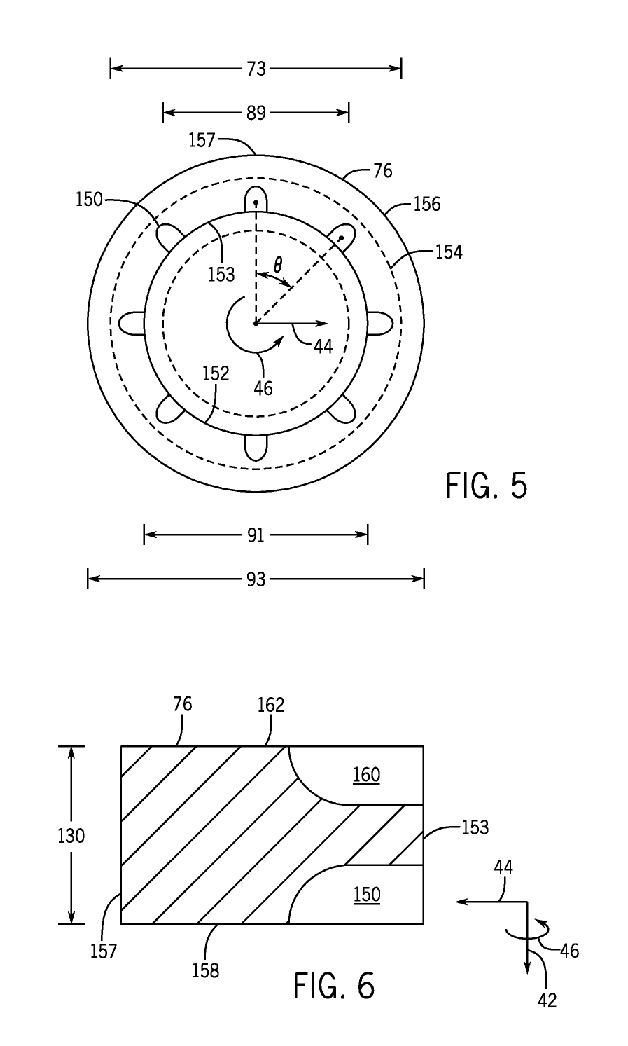

FIGS. 5 and 6 show an embodiment in which the top ring 76 has recesses 150 disposed about the inside circumference 152 of the top ring, defined by the inside diameter 91 of the top ring. FIG. 5 is a bottom view of an embodiment of the top ring 76 in which the top ring 76 has 8 recesses 150 disposed circumferentially 46 around the inside circumference 152 of the top ring 76. Recesses may be separated by an angle, θ, or extend circumferentially about the interior circumference 152, spanning an angle, θ. Though FIG. 5 shows 8 recesses 150, it should be understood that this is merely for example and that the top ring 76 may have any number of recesses 150. For example, the top ring 76 may have a single annular recess 150 disposed all the way around the interior circumference 152 of the top ring 76. Alternatively, the top ring may have 2, 3, 4, 5, 6, 7, 8, 9, 10, 12, 14, 16, 18, 20, 22, 24 recesses 150, or any other number of recesses 150 at discrete locations disposed circumferentially 46 about the top ring 76. The recesses 150 may extend radially outward 44 from the inside surface 153 of the top ring 76 toward the outside circumference 156 (or outside surface 157) to a point inside of the outer circumference 154 of the piston 54. The recesses 150 do not extend beyond the outer circumference 154 of the piston 54, the top ring 76 to ensure formation of a seal with the bottom surface 134 of the top ring groove 80 during the power stroke. The recesses 150 also extend circumferentially about the interior circumference 152 of the top ring 76. In some embodiments, a single recess may extend around the entire interior circumference 152 of the top ring 76. In other embodiments, one or more recesses may extend circumferentially part way around the interior circumference 152 of the top ring 76. As shown in FIGS. 2, 3, and 4, the outside diameter 156 of the top ring 76 is larger than that of the piston 54 such that the outer circumference of the top ring 156 extends beyond the outer circumference 154 of the piston 54.

FIG. 6 is a section view of an embodiment of the top ring 76 having one or more recesses 150 on the bottom surface 158 of the top ring 76. As can be seen in FIG. 6, the recess 150 extends axially 42 from the bottom surface 158, the top surface 162, or both, into the top ring 76, but does not extend through the entire height 130 of the top ring 76. Though one or more recesses 150 on the bottom surface 158 of the top ring may help the top ring 76 to lift during exhaust and intake, a second set of one or more recesses 160 may be disposed in the top surface 162 of the top ring in order to keep the ring from twisting in operation. The one or more recesses 160 in the top of the top ring 76 may mirror the recesses 150 on the bottom of the ring (e.g., there may be an equal number of bottom recesses 150 and top recesses 160, the recesses 160 may be placed in similar locations about the circumference 152 of the top ring, extend a similar distance radially 44 into the top ring, and extend a similar distance axially 42 into the top ring 76. In some embodiments, the top recesses 160 of the top ring 76 may mirror the bottom recesses 150 of the top ring 76 in order to reduce or eliminate twisting of the ring during operation. In other embodiments, the top recesses 160 of the top ring 76 may be offset from the bottom recesses 150 of the top ring 76, but configured such that the neutral axis in the radial direction is centered, so as to reduce or eliminate twisting of the ring during operation However, in other embodiments, there may be a different number of top recesses 160 than bottom recesses 150, the one or more top recesses 160 may be disposed in different positions, or extend different dimensions into the top ring radially 44 or axially 42.

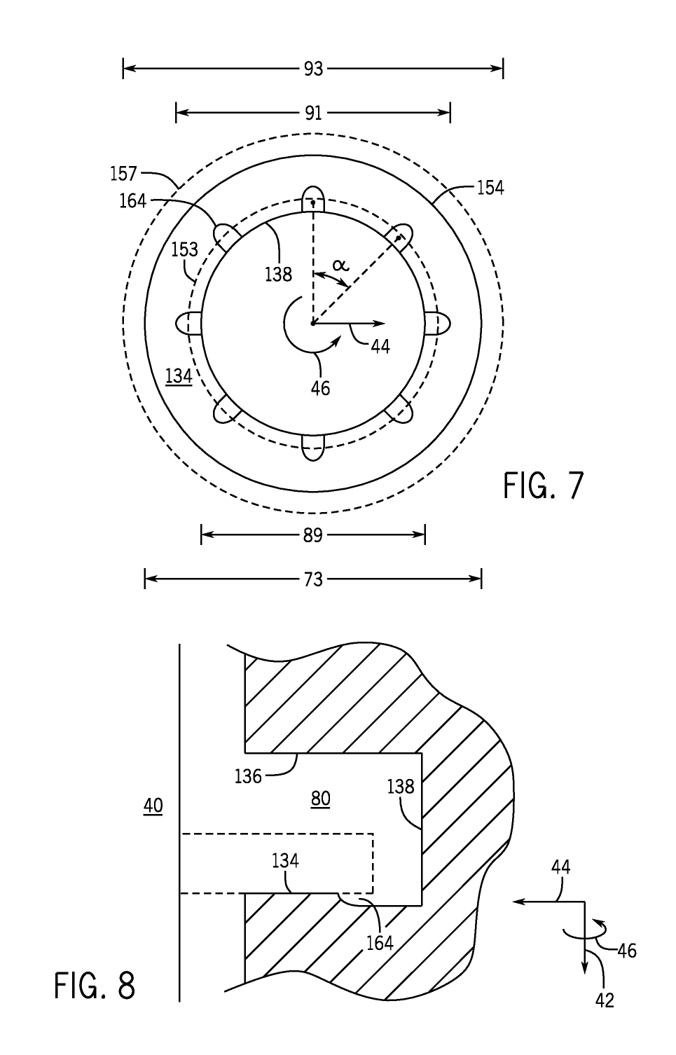

FIG. 7 is a top-section view of an embodiment of the piston 54 having a top ring groove 80 with 8 recesses 164 in the bottom surface 134, disposed circumferentially 46 around the inside surface 138 of the top ring groove 80. The recesses 164 may be separated by an angle, a, or extend circumferentially 46 about the interior surface 138 of the piston, spanning an angle, a. Though FIG. 7 shows 8 recesses 164, it should be understood that this is merely an example and that the bottom surface 134 of the top ring groove 80 may have any number of recesses 164. For example, the bottom surface 134 of the top ring groove 80 may have a single annular recess 164 disposed all the way around the interior surface 138 of the top ring groove 80. Alternatively, the bottom surface 134 of the top ring groove 80 may have 2, 3, 4, 5, 6, 7, 8, 9, 10, 12, 14, 16, 18, 20, 22, 24 recesses 164, or any other number of recesses 164 disposed at discrete locations circumferentially 46 about the top ring groove 80. The recesses 164 may extend radially outward 44 from the inside surface 138 of the top ring groove 80, or any point between the inside surface 138 of the top ring groove and the inside surface 153 of the top ring 76 toward the outside circumference 154 to a point beyond the inside circumference 152 of the top ring 76. The recesses 164 extend beyond the inside circumference 152 of the top ring 76 to enable the pressure to “get behind” the top ring 76 and enable top ring 76 lift during exhaust and intake. The recesses 164 also extend circumferentially about the interior circumference 138 of the top ring groove 80. In some embodiments, a single recess 164 may extend around the entire interior circumference 138 of the top ring groove 80. In other embodiments, one or more recesses 164 may extend circumferentially part of the way around the interior circumference 138 of the top ring groove 80. As shown in FIGS. 2, 3, 5, and 7, the outside diameter 156 of the top ring 76 is larger than that of the piston 54 such that the outer circumference of the top ring 156 extends beyond the outer circumference 154 of the piston 54.

FIG. 8 is a side-section view of the embodiment of the piston 54 having a top ring groove 80 with 8 recesses 164 in the bottom surface 134 shown in FIG. 7. The recess 164 extends in the axial direction 42, in the radial direction 44, and circumferentially 46. It should be understood that top ring 76 lift may be achieved with a recess 150 in the bottom of the top ring 76, a recess 164 in the bottom of the top ring groove 80, or both. The recess 164 enables the pressure in the combustion portion 68 to “get behind” the top ring 76, reducing the effective force F_{P} due to the pressure in the combustion portion 68 pushing downward on the top ring 76. By reducing the pressure, or the effective force F_{P} due to the pressure in the combustion portion 68, pushing downward on the top ring 76 enables the inertial force F_{I} to exceed Fₚ during exhaust and intake (when the inertia force F_{I} acts upwards), resulting in top ring 76 lift. Furthermore, by reducing F_{P} throughout the engine cycle, including during the high pressure portion of the expansion stroke, wear on the bottom surface 158 of the top ring 76 and the bottom surface 134 of the top ring groove 80 may be reduced.

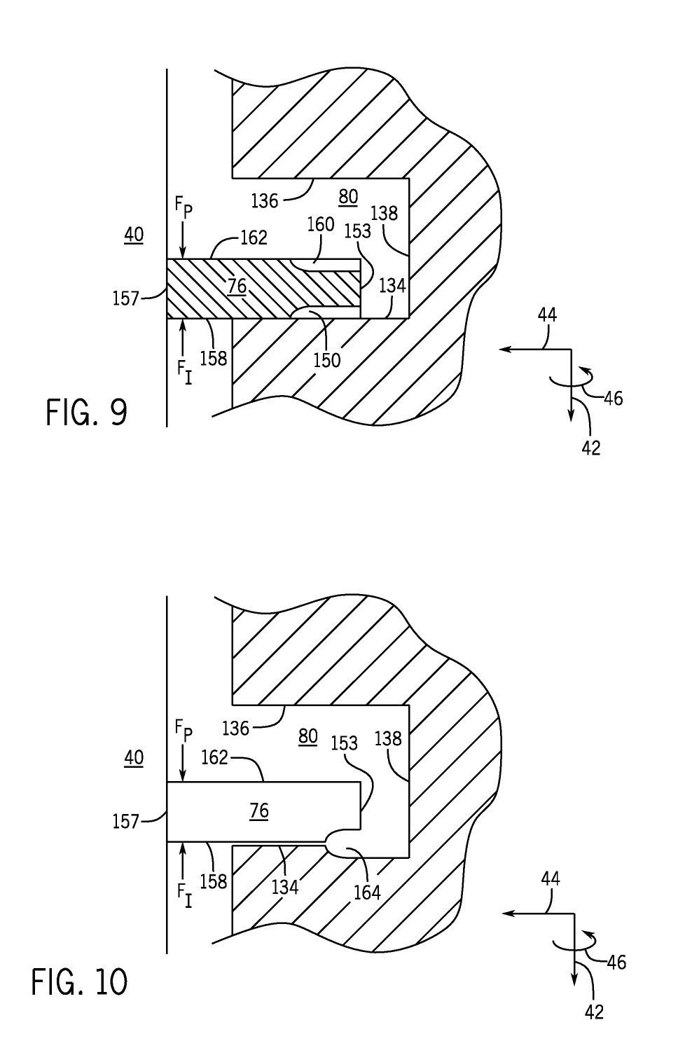

FIGS. 9 and 10 show two embodiments in which there is at least one recess at the interface of the bottom surface 158 of the top ring 76 and the bottom surface 134 of the top ring groove 80, respectively, in order to encourage top ring 76 lift and minimize wear at the interface of the bottom surface 158 of the top ring 76 and the bottom surface 134 of the top ring groove 80. FIG. 9 shows an embodiment in which the top ring 76 has one set of one or more bottom recesses 150 and one set of one or more top recesses 160. As previously discussed, the top recesses 160 may or may not mirror the bottom recesses. Furthermore, it should be understood that the top recesses 160 are to keep the top ring from twisting 76 and may not be included in some embodiments. As can be seen in FIG. 9, the bottom recesses 150 enable the pressure in the combustion portion 68 to “get behind” the top ring 76 such that the pressure in the combustion portion 68 is enabled to act on the bottom surface 158 of the top ring 76, thus reducing the effective force F_{P} due to the pressure in the combustion portion 68 pushing downward (in the axial direction 42) on the top ring 76.

In turbocharged engines 12, or other engines in which the pressure in the combustion portion 68 is high during exhaust and intake, reducing the effective force F_{P} due to the pressure in the combustion portion 68 pushing downward on the top ring 76 enables the inertial force F_{I} acting upward on the top ring 76 to exceed F_{P} during exhaust and intake, resulting in top ring 76 lift.

FIG. 10 shows an embodiment in which the bottom surface 134 of the top ring groove 80 has a recess 164 that extends in the axial direction 42, in the radial direction 44, and circumferentially 46. It should be understood that top ring 76 lift may be achieved with a recess 150 in the bottom of the top ring 76, a recess 164 in the bottom of the top ring groove 80, or both. As with the embodiment shown in FIG. 9, the recess 164 enables the pressure in the combustion portion 68 to “get behind” the top ring 76 such that the pressure in the combustion portion 68 is enabled to act on the bottom surface 158 of the top ring 76, thus reducing the effective force F_{P} due to the pressure in the combustion portion 68 pushing downward on the top ring 76. By reducing the pressure, or the effective force F_{P} due to the pressure in the combustion portion 68, pushing downward on the top ring 76 enables the inertial force F_{I} acting upward on the top ring 76 to exceed F_{P} during exhaust and intake, resulting in top ring 76 lift.

Technical effects of the claimed subject matter include recesses in the interface between the bottom surface of the top ring and the bottom surface of the top ring groove, which help to reduce the force pushing downward on the top ring in the longitudinal direction due to pressure in the combustion portion. Reducing the pressure, or the force due to pressure, pushing down on the top ring, encourages top ring lift during exhaust and intake. A top ring that lifts scrubs the top ring groove, keeping the groove free of carbon deposits. Additionally, wear on the bottom surface 158 of the top ring 76 and the bottom surface 134 of the top ring groove 80 may be reduced.

This written description uses examples to disclose the claimed subject matter, including the best mode, and also to enable any person skilled in the art to practice the claimed subject matter, including making and using any devices or systems and performing any incorporated methods. The patentable scope of the claimed subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a piston having a first outer diameter and comprising:
an annular ring groove configured to receive a ring, wherein the annular ring groove is defined by a top surface, a bottom surface, and an inner surface that extends between the top surface and the bottom surface in an axial direction along a longitudinal axis of the piston, the inner surface has an inner diameter that is less than the outer diameter, and wherein the bottom surface has a recess that extends both in the axial direction and a radial direction relative to the longitudinal axis.

2. The system of claim 1, comprising a combustion engine having the piston.

3. The system of claim 1, wherein the recess is annular in shape and extends in a circumferential direction about the inner surface.

4. The system of claim 2, comprising the ring, wherein the recess, during operation of the combustion engine, reduces the pressure load acting on the ring in the axial direction.

5. The system of claim 1, wherein the bottom surface comprises a plurality of recesses that extend in both the axial direction and radial direction, and the plurality of recesses are spaced apart about the bottom surface in a circumferential direction relative to the longitudinal axis.

6. The system of claim 1, wherein the recess partially extends along the bottom surface in the radial direction.

7. The system of claim 6, wherein the recess extends from the inner surface, or a first point between the inner surface of the ring groove and an inside surface of the ring in the radial direction, to a second point beyond an inside circumference of the ring, wherein the inside surface of the ring groove extends in the axial direction, extends circumferentially about the longitudinal axis, and is defined by the inside circumference of the ring.

8. The system of claim 6, wherein the recess partially extends along the bottom surface in a circumferential direction relative to the longitudinal axis.

9. A system, comprising:
a ring configured to be disposed within an annular ring groove of a piston within a combustion engine, wherein the ring has a top surface, a bottom surface, an inner surface extending between the top and bottom surfaces and defining an inner diameter of the ring, and an outer surface extending between the top and bottom surfaces and defining an outer diameter of the ring, and wherein the ring comprises a first recess in the bottom surface that during operation of the combustion engine reduces the pressure load acting on the ring in an axial direction relative to a longitudinal axis of the piston, and the recess extends in both the axial direction and a radial direction relative to the longitudinal axis.

10. The system of claim 9, comprising the piston and the combustion engine having the piston and the ring.

11. The system of claim 9, wherein the top surface comprises a second recess.

12. The system of claim 9, wherein the second recess partially extends along the top surface in the radial direction.

13. The system of claim 9, wherein the ring comprises a first plurality of recesses in the bottom surface, including the first recess.

14. The system of claim 13, wherein the ring comprises a second plurality of recesses in the top surface, including the second recess, wherein the second plurality of recesses are designed such that a neutral axis of the ring in the radial direction is centered.

15. The system of claim 14, wherein the second plurality of recesses mirror the first plurality of recesses about a radial plane that extends in the radial direction and is perpendicular to the longitudinal axis.

16. The system of claim 9, wherein the first recess partially extends along the bottom surface in the radial direction.

17. The system of claim 16, wherein the recess extends from the inner diameter in the radial direction.

18. The system of claim 16, wherein the first recess partially extends along the bottom surface in a circumferential direction relative to the longitudinal axis.

19. A system comprising:
a turbocharger;
a combustion engine fluidly coupled to the turbocharger and comprising:
a piston having a first outer piston diameter and comprising an annular ring groove configured to receive a ring, wherein the annular ring groove is defined by a top groove surface, a bottom groove surface, and an inner groove surface that extends between the top groove surface and the bottom groove surface in an axial direction along a longitudinal axis of the piston, the inner groove surface has an inner groove diameter that is less than the outer piston diameter, and wherein the bottom groove surface has a groove recess that extends both in the axial direction and a radial direction relative to the longitudinal axis; and
a ring configured to be disposed within the annular ring groove, wherein the ring has a top ring surface, a bottom ring surface, an inner ring surface extending between the top ring surface and bottom ring surface and defining an inner ring diameter of the ring, and an outer ring surface extending between the top ring surface and bottom ring surface and defining an outer ring diameter of the ring, and wherein the ring comprises:
a top recess in the top ring surface extending in both the axial direction and a radial direction relative to the longitudinal axis; and
a bottom recess in the bottom ring surface that during operation of the combustion engine reduces the pressure load acting on the ring in an axial direction relative to a longitudinal axis of the piston, wherein the bottom recess extends in both the axial direction and a radial direction relative to the longitudinal axis.

20. The system of claim 19, wherein the groove recess extends in the radial direction from a point inside of the inner ring diameter to a point inside of the first outer piston diameter.
